(19) United States
(12) Patent Application Publication
(10) Pub. No.: US 2017/0339579 A1
(43) Pub. Date: Nov. 23, 2017

(54) Device to Device Interference Coordination Method, Device, Base Station and User Equipment

(71) Applicant: ZTE Corporation, Shenzhen (CN)

(72) Inventors: Li CHU, Shenzhen (CN); Lin CHEN, Shenzhen (CN)

(21) Appl. No.: 15/518,004

(22) PCT Filed: Jun. 24, 2015
(86) PCT No.: PCT/CN2015/082230

§ 371 Date: Jul. 17, 2017

(30) Foreign Application Priority Data
Oct. 9, 2014 (CN) 201410529421.3

(51) Int. Cl. H04W 24/02; H04W 72/12; H04W 72/08

(52) U.S. Cl. CPC H04W 24/02; H04W 72/082; H04W 72/121

(57) ABSTRACT

The at least one of embodiments of disclosure provides a method and device for Device to Device (D2D) interference coordination, a base station and a User Equipment (UE). The method includes that: a base station acquires D2D interference sensitivity information, wherein the D2D interference sensitivity information is used for indicating a level of sensitivity to interference of a D2D transmission performed on radio resources or indicating a level of sensitivity to interference of a D2D transmission to be performed on radio resources; the base station performs interference coordination according to the D2D interference sensitivity information.

### TECHNICAL FIELD

The disclosure relates to the field of communications, and in particular to a method and device for Device to Device (D2D) interference coordination, a base station and a User Equipment (UE).

### BACKGROUND

With a development of wireless multimedia services, on one hand, people have growing requirements for high data rate and user experience, so a higher system capacity and coverage of a traditional cellular network is required; on the other hand, a popularity of social networking services, short-range data sharing, local advertising and other applications makes people have growing requirements for Proximity Services (PS) which are used for knowing people or things of interest nearby and communicating with the people or things of interest nearby. A traditional cell-based cellular network has obvious limitations in supporting the high data rate and the PS; in such a requirement background, a D2D technology representing a new development trend of communication technology in future emerges as required. An application of the D2D technology can lighten a burden of the cellular network, reduce battery power consumption of a UE, improve the data rate, and improve a robustness of network infrastructure, so the D2D technology meets the requirements for high data rate services and the PS well.

The D2D technology can work in an authorized frequency band or an unauthorized frequency band, and allow multiple UEs supporting a D2D function (namely D2D UE) to perform direct discovery or directly communication in the case of network infrastructure or in the absence of network infrastructure. There are three main application scenarios of D2D as follows:

1) a UE1 and a UE2 perform data interaction under a coverage of cellular network, and user plane data does not pass through the network infrastructure, as a mode 1 in FIG. 1;

2) a UE in an area with poor coverage or without coverage performs a relay transmission, as a mode 2 in FIG. 1; a UE4 with poor signal quality is allowed to communicate with a network through a UE3 with network coverage nearby, which can help operators to extend coverage and improve capacity; and

3) when the cellular network cannot work normally because of earthquake or emergency, devices are allowed to communicate directly, as a mode 3 in FIG. 1; control planes and user planes among a UE5, a UE6 and a UE7 perform one-hop or multi-hop data communication without passing through the network infrastructure.

The D2D technology usually includes a D2D discovery technology and a D2D communication technology.

1) The D2D discovery technology is used for judging or determining that two or multiple D2D UEs are adjacent to each other (for example, within a range that they can perform D2D direct communication) or used for judging or determining that a first UE is adjacent to a second UE.

2) The D2D communication technology is that part or all of communication data among the D2D UE can directly communicate without passing through the network infrastructure.

The D2D UE needs to first acquire corresponding radio resources before performing D2D discovery or D2D communication; whether for D2D discovery resources or D2D communication resources, there are two resource allocation modes, that is, resource acquisition based on competition (a first resource allocation mode), or a base station allocates an exclusive resource to the UE (a second resource allocation mode) to perform the D2D discovery or the D2D communication. The first resource allocation mode is usually that a base station or a system allocates a D2D resource pool in advance, then the D2D UE participating in the D2D discovery or the D2D communication monitors the resource pool, and acquires D2D sending resources by means of competition. This mode is mainly used for the D2D UE outside the coverage of the cellular network or the D2D UE within the coverage of the cellular network. The D2D UE within the coverage of the cellular network can use a D2D competition resource pool configured by the cell, which is served by the D2D UE. The D2D UE outside the coverage of the cellular network can use a preconfigured D2D competition resource pool. The second resource allocation mode is that the base station allocates proper D2D resources to the D2D UE according to a request of the D2D UE. This mode can be used for the D2D UE within the coverage of the cellular network.

For the D2D discovery and the D2D communication, if the D2D UE within the coverage of the cellular network adopts the resource acquisition based on competition, the D2D UE can acquire the D2D resource pool from the base station, and then select resources by means of competition from the resource pool to perform D2D sending.

Generally, D2D transmission and cellular transmission share resources; D2D resources between adjacent cells may be the same or different. For a scenario where the D2D transmission and the cellular transmission between the adjacent cells coexist, as shown in FIG. 2, the UE1 and the UE2 are under the base station eNB1, the UE3, the UE4 and the UE5 are under the base station eNB2, and all of them are in an edge area of the corresponding cell. When the UE1 performs the D2D sending (which means signal transmission of the D2D discovery or the D2D communication) under the eNB1, the UE2 and the UE3 are performing corresponding D2D monitoring or receiving the D2D sending of the UE1; when the UE4 performs the D2D sending under the eNB2, the UE5 is performing corresponding D2D monitoring or receiving the D2D sending of the UE4. If the eNB1 and the eNB2 allocate the same D2D resource to the UE1 and the UE4, mutual interference may occur between the D2D transmission of the UE4 and the D2D transmission of the UE1; if the UE3 hopes to monitor or receive the D2D sending of both the UE1 and the UE4, then because D2D resources of the UE1 and the UE4 have conflict, the UE only having a half-duplex capability cannot monitor or receive normally.

When the UE4 has the cellular transmission, if cellular transmission resources allocated to the UE4 by the eNB2 is the same as D2D transmission resources allocated to the UE1 by the eNB1, mutual interference may occur between the cellular transmission of the UE4 and the D2D transmission of the UE1.

Generally, the D2D transmission adopts uplink resources of the existing cellular communication, interference between the D2D transmission and the cellular transmission is mainly the interference between the D2D transmission and cellular uplink transmission. If the D2D transmission adopts downlink resources of the existing cellular communication, interference may also occur between the D2D transmission and cellular downlink transmission.

In the related art, aiming at a problem of interference between cellular transmissions of adjacent cells, interference coordination is performed through inter-cell interaction based on forward scheduling; a main method is as follows:

a High Interference Indicator (HII) mechanism: interference sensitivity of each Resource Block (RB) is provided to a adjacent base station in a form of a bit map list, a value of each bit can be 0 or 1, which indicates a possibility that at least one UE at the cell edge will be scheduled on some frequency bands to perform uplink transmission sometime.

However, the related art cannot either provide information about the D2D transmission or differentiate which information is related to interference between the cellular communications and which information is related to an interference of the D2D transmission. Because load levels of the D2D transmission resources and the cellular transmission resources are different, and a policy and priority of the D2D transmission is different from that of the cellular transmission according to the difference of practical applications, there are different considerations on corresponding interference processing and scheduling. So, the problem of interference or resource conflict resulting from the inter-cell D2D transmission requires a targeted solution, otherwise it has a large impact on effects of the D2D transmission and the cellular transmission, causes poor receiving performance, and seriously influences user experience of related services.

Aiming at the problem in the related art of poor receiving performance in D2D transmission and cellular transmission resulting from interference or resource conflict caused by inter-cell D2D transmission, an effective solution has not been presented.

### SUMMARY

The at least one of embodiment of disclosure provides a method and device for D2D interference coordination, a base station and a UE, so as to at least solve the problem of poor receiving performance in D2D transmission and cellular transmission resulting from interference or resource conflict caused by inter-cell D2D transmission.

In one embodiment of the disclosure, a method for D2D interference coordination is provided, which includes that: acquiring, by a base station, D2D interference sensitivity information, wherein the D2D interference sensitivity information is used for indicating a level of sensitivity to interference of a D2D transmission performed on radio resources or indicating a level of sensitivity to interference of a D2D transmission to be performed on radio resources; and performing, by the base station, interference coordination according to the D2D interference sensitivity information.

In an example embodiment, acquiring, by the base station, the D2D interference sensitivity information includes at least one of the followings: receiving, by the base station, the D2D interference sensitivity information sent by a User Equipment (UE) or an adjacent base station; generating, by the base station, the D2D interference sensitivity information according to an interference status of the radio resources.

In an example embodiment, the D2D interference sensitivity information includes at least one of the followings: valid time of the D2D interference sensitivity information, duration time of the D2D transmission, a group identifier of the D2D transmission, a priority of the D2D transmission, and resource information corresponding to the D2D transmission.

In an example embodiment, performing interference coordination according to the D2D interference sensitivity information includes at least one of the followings: performing, by the base station, resource allocation or scheduling adjustment for the D2D transmission according to the D2D interference sensitivity information; sending, by the base station, the D2D interference sensitivity information to an adjacent base station of the base station; and sending, by the base station, the D2D interference sensitivity information to a processing center.

In an example embodiment, performing, by the base station, resource allocation or scheduling adjustment for the D2D transmission according to the D2D interference sensitivity information includes: determining, by the base station, the level of sensitivity to interference of the D2D transmission performed, by a sender of the D2D interference sensitivity information, on the radio resources according to the D2D interference sensitivity information; when the level of sensitivity is higher than a first preset value, preferentially scheduling on the radio resources a cellular transmission or a D2D transmission which is not easy to interfere with a cell, or not scheduling any transmission.

In an example embodiment, when the D2D transmission is a transmission in a cell, performing, by the base station, resource allocation or scheduling adjustment for the D2D transmission according to the D2D interference sensitivity information includes at least one of the followings: when the priority of the D2D transmission is higher than a second preset value, scheduling, by the base station, a transmission with lower power, or a cellular transmission or a D2D transmission of the UE at a center of the cell on the radio resources corresponding to the D2D interference sensitivity information, or not scheduling any transmission of the UE; when the priority of the D2D transmission is not higher than the second preset value, scheduling, by the base station, a transmission with higher priority of the UE at a center or an edge of the cell on the radio resource corresponding to the D2D interference sensitivity information.

In an example embodiment, when the D2D interference sensitivity information includes a priority of the D2D transmission, performing, by the base station, resource allocation or scheduling adjustment for the D2D transmission according to the D2D interference sensitivity information includes at least one of the followings: when the priority of the D2D transmission is higher than the second preset value, scheduling, by the base station, a transmission with lower power, or the cellular transmission or the D2D transmission of the UE at a center of the cell on the radio resources corresponding to the D2D interference sensitivity information, or not scheduling any transmission of the UE; when the priority of the D2D transmission is not higher than the second preset value, scheduling, by the base station, a transmission with higher priority of the UE at a center or an edge of the cell on the radio resources corresponding to the D2D interference sensitivity information.

In an example embodiment, when the D2D interference sensitivity information includes the duration time of the D2D transmission, performing, by the base station, resource allocation or scheduling adjustment for the D2D transmission according to the D2D interference sensitivity information includes: within the duration time of the D2D transmission, scheduling, by the base station, a transmission with lower power, or the cellular transmission or the D2D transmission of the UE at a center of the cell on the radio resources corresponding to the D2D interference sensitivity information, or not scheduling any transmission of the UE.

In an example embodiment, sending, by the base station, the D2D interference sensitivity information to the adjacent base station of the base station includes: determining, by the base station, a possible interference source cell or a base station according to at least one of the D2D interference sensitivity information and D2D resource information of the adjacent base station; and sending, by the base station, the D2D interference sensitivity information to the determined possible interference source cell or base station.

In an example embodiment, the processing center includes at least one of the followings: an Operation Administration and Maintenance (OAM) entity, a Mobile Management Entity (MME) and a centralized information center.

In an example embodiment, the radio resources corresponding to the D2D interference sensitivity information take one of a D2D transmission resource element, a D2D communication resource element, a D2D Scheduling Assignment (SA) resource element and a D2D discovery resource element as an element, or take a Physical Resource Block (PRB) as an element.

In an example embodiment, in a bit map carried in the D2D interference sensitivity information, a length of the bit map corresponding to D2D discovery or D2D communication is the same as a number of one of discovery resources, SA resources and data PRBs contained in the D2D resources.

In an example embodiment, when the D2D resources of the cell of the base station are divided into a part used for the D2D transmission of the UE at the center of the cell or the D2D transmission with lower power of the UE, and a part used for the D2D transmission of the UE at the edge of the cell or the D2D transmission of with higher power the UE, the length of the bit map carried in the D2D interference sensitivity information is the same as the number of the resources used for the D2D transmission of the UE at the edge of the cell or the D2D transmission with higher power of the UE.

In an example embodiment, block information of the D2D resources is configured through an interaction between adjacent cells, or is configured by an OAM.

In an example embodiment, the D2D interference sensitivity information and interference status information of existing cellular resources are indicated uniformly in an Information Element (IE), or indicated separately.

In an example embodiment, the D2D interference sensitivity information reuses overload indication information, or is indicated by using a new IE.

In an example embodiment, the D2D interference sensitivity information is carried in an X2 load information message.

In another embodiment of the disclosure, a method for D2D interference coordination is also provided, which includes that: sending to a base station, by a Equipment (UE), D2D interference sensitivity information which is used for indicating a level of sensitivity to interference of a D2D transmission performed on radio resources or indicating a level of sensitivity to interference of a D2D transmission to be performed on radio resources, wherein the D2D interference sensitivity information is used for indicating the base station to perform interference coordination.

In an example embodiment, the D2D interference sensitivity information includes at least one of the followings: valid time of the D2D interference sensitivity information, duration time of the D2D transmission, a group identifier of the D2D transmission, a priority of the D2D transmission, and resource information corresponding to the D2D transmission.

In an example embodiment, a triggering way of sending, by the UE, the D2D interference sensitivity information to the base station includes one of the followings: event triggering, periodic reporting, and timer triggering.

In an example embodiment, the event triggering includes at least one of the following ways: the UE detects interference or resource conflict of the D2D transmission; the UE receives a reporting request for indicating the UE to report the D2D interference sensitivity information from the base station; and the UE has a D2D transmission resource requirement, or has a D2D signal or D2D data to be transmitted.

In an example embodiment, the periodic reporting includes: collecting, by the UE, a D2D interference level corresponding to each resource granularity, and periodically reporting an average value of the D2D interference level corresponding to each resource granularity, wherein a resource element of each resource granularity includes at least one of the followings: a D2D discovery resource element, a Scheduling Assignment (SA) resource element, a data resource element, and a Physical Resource Block (PRB).

In an example embodiment, sending, by the UE, the D2D interference sensitivity information to the base station includes: reporting, by the UE, the D2D interference sensitivity information through one of terminal assistance information, measurement report, Radio Resource Control (RRC) connection setup and Tracking Area Update (TAU) request process, and a new message.

In another embodiment of the disclosure, a device for D2D interference coordination is also provided, which is applied to a base station, and includes: an acquiring component, which is arranged to acquire D2D interference sensitivity information, wherein the D2D interference sensitivity information is used for indicating a level of sensitivity to interference of a D2D transmission performed on radio resources or indicating a level of sensitivity to interference of a D2D transmission to be performed on radio resources; and a coordinating component, which is arranged to perform interference coordination according to the D2D interference sensitivity information.

In an example embodiment, the coordinating component includes at least one of the followings: a scheduling element, which is arranged to perform resource allocation or scheduling adjustment for the D2D transmission according to the D2D interference sensitivity information; a first sending element, which is arranged to send the D2D interference sensitivity information to an adjacent base station of the base station; and a second sending element, which is arranged to send the D2D interference sensitivity information to a processing center.

In an example embodiment, the scheduling element includes: a first determining subelement, which is arranged to determine the level of sensitivity to interference of the D2D transmission performed, by a sender of the D2D interference sensitivity information, on the radio resources according to the D2D interference sensitivity information; a scheduling subelement, which is arranged to, when the level of sensitivity is higher than a first preset value, preferentially schedule on the radio resources a cellular transmission or a D2D transmission which is not easy to interfere with a cell, or not schedule any transmission.

In an example embodiment, the first sending element includes: a second determining subelement, which is arranged to determine a possible interference source cell or a base station according to at least one of the D2D interference sensitivity information and D2D resource information of the adjacent base station; and a first sending subelement, which is arranged to send the D2D interference sensitivity information to the determined possible interference source cell or base station.

In an example embodiment, the acquiring component includes at least one of the followings: a receiving element, which is arranged to receive the D2D interference sensitivity information sent by a User Equipment (UE) or a adjacent base station; and a generating element, which is arranged to generate the D2D interference sensitivity information according to an interference status of the radio resources.

In another embodiment of the disclosure, a device for D2D interference coordination is also provided, which is applied to a UE, and includes: a sending component, which is arranged to send D2D interference sensitivity information which is used for indicating a level of sensitivity to interference of a D2D transmission performed on radio resources or indicating a level of sensitivity to interference of a D2D transmission to be performed on radio resources, wherein the D2D interference sensitivity information is used for indicating the base station to perform interference coordination.

In another embodiment of the disclosure, a base station is also provided, which includes the device for D2D interference coordination, which is applied to the base station.

In another embodiment of the disclosure, a UE is also provided, which includes the device for D2D interference coordination, which is applied to the UE.

According to the embodiment of the disclosure, the base station acquires the D2D interference sensitivity information, in which the D2D interference sensitivity information is used for indicating the level of sensitivity to interference of the D2D transmission performed on radio resources or indicating the level of sensitivity to interference of the D2D transmission to be performed on the radio resources; and the base station performs interference coordination according to the D2D interference sensitivity information; in such a manner, the problem of poor receiving performance in D2D transmission and cellular transmission resulting from interference or resource conflict caused by inter-cell D2D transmission is solved, the receiving performance is enhanced, thereby improving the user experience.

### BRIEF DESCRIPTION OF THE DRAWINGS

The accompanying drawings described here are used for providing a deeper understanding of the disclosure, and constitute a part of the application; schematic embodiments of the disclosure and description thereof are used for illustrating the disclosure and not intended to form an improper limit to the disclosure. In the accompanying drawings:

FIG. 1 is a structural schematic diagram of a D2D transmission network according to the related art;

FIG. 2 is a schematic diagram of a scenario where a D2D transmission and a cellular transmission between adjacent cells coexist according to the related art;

FIG. 3 is a flowchart of a method for D2D interference coordination according to an embodiment of the disclosure;

FIG. 4 is a structural schematic diagram of a device for D2D interference coordination according to an embodiment of the disclosure;

FIG. 5 is a structural schematic diagram of a device for D2D interference coordination according to a first example embodiment of the disclosure;

FIG. 6 is a structural schematic diagram of a device for D2D interference coordination according to a second example embodiment of the disclosure;

FIG. 7 is a structural schematic diagram of a device for D2D interference coordination according to a third example embodiment of the disclosure; and

FIG. 8 is a structural schematic diagram of a device for D2D interference coordination according to a fourth example embodiment of the disclosure.

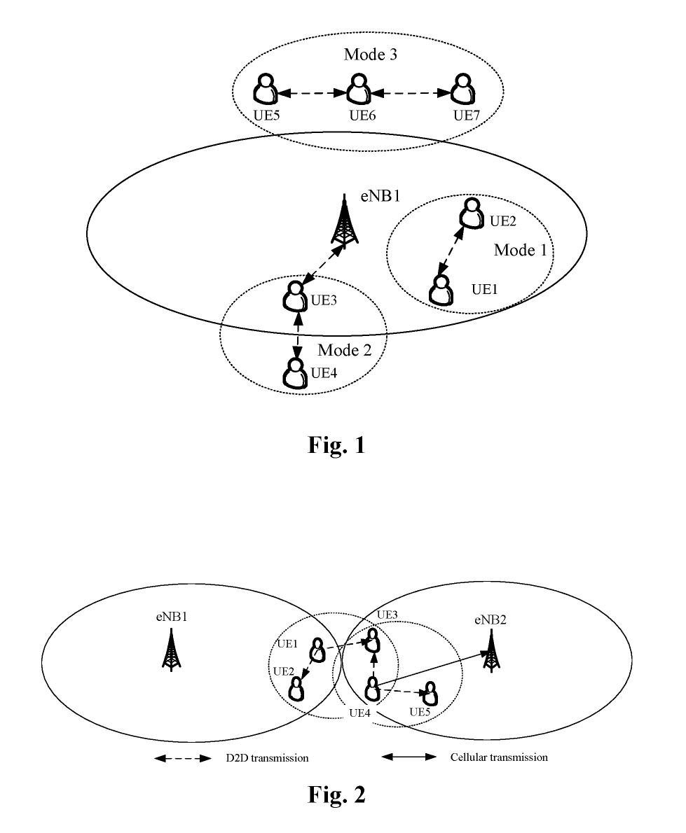

### DETAILED DESCRIPTION

It needs to be noted that the embodiments of the disclosure and the characteristics in the embodiments can be combined under the condition of no conflicts. The disclosure is described below with reference to the accompanying drawings and embodiments in detail.

These steps presented in the flowchart of the accompanying drawings can be executed in a computer system like a group of machine-executable instructions; besides, although a logical sequence is shown in the flowchart, in some cases, the presented or described steps can be performed in a sequence different from that described here.

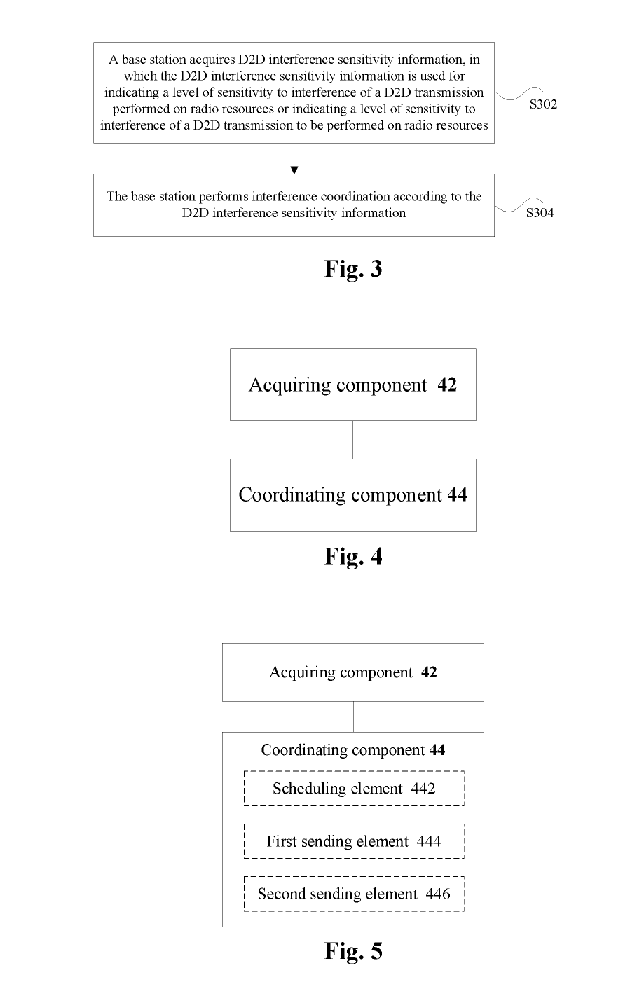

The present embodiment provides a method for D2D interference coordination; FIG. 3 is a flowchart of a method for D2D interference coordination according to an embodiment of the disclosure; as shown in FIG. 3, the flow includes the following steps:

At S302: a base station acquires D2D interference sensitivity information, in which the D2D interference sensitivity information is used for indicating a level of sensitivity to interference of a D2D transmission performed on radio resources or indicating a level of sensitivity to interference of a D2D transmission to be performed on radio resources; and

At S304: the base station performs interference coordination according to the D2D interference sensitivity information.

Through the above steps, by sending the D2D interference sensitivity information to the base station, the base station can perform interference coordination to the D2D transmission being performed or the D2D transmission to be performed; in such a manner, the problem of poor receiving performance in the D2D transmission and the cellular transmission resulting from interference or resource conflict caused by the inter-cell D2D transmission is solved, and receiving performance and D2D communication service quality are enhanced, thereby improving the user experience.

In an example embodiment, the D2D interference sensitivity information indicates the level of sensitivity to interference of the D2D transmission performed on the radio resources or indicates the level of sensitivity to interference of the D2D transmission to be performed on the radio resources. Furthermore, the D2D interference sensitivity information indicates whether to schedule, on the corresponding resources, the D2D transmission of the UE at the edge or the D2D transmission with a higher level of sensitivity to interference or a higher priority. The different values of the level of sensitivity to interference respectively indicate the different levels of sensitivity to interference of the D2D transmission on the corresponding resource. In addition, the D2D interference sensitivity information indicates the level of sensitivity to interference, which can be high, medium and low for representing different levels of sensitivity to interference.

The high level means that the adjacent base station is required to not schedule on the resources the cellular transmission or the D2D transmission which is easy to interfere with the cell, for example, the transmission of the UE at the edge of the cell or the transmission with higher power.

The D2D interference sensitivity information includes one of the followings: time, the group identifier of the D2D transmission, the priority, the resource information corresponding to the D2D transmission, and so on. The time indicates the valid time of the D2D interference sensitivity information or the duration time of the D2D transmission.

After receiving the D2D interference sensitivity information, the adjacent base station performs the corresponding interference coordination according to the D2D interference sensitivity information. For example, when the D2D interference sensitivity information is high, the adjacent base station tries not to schedule on the resources the cellular transmission or the D2D transmission which is easy to interfere with the cell, e.g., the transmission of the UE at the edge of the cell or the transmission with higher power.

After receiving the D2D interference sensitivity information, the adjacent base station performs the corresponding interference coordination according to the group number or the priority of the D2D transmission in the information. For example, when the priority of the D2D transmission is higher, the base station schedules, on the corresponding resources corresponding to the D2D interference sensitivity information, the cellular transmission or the D2D transmission of the UE at the center of the cell or the transmission with lower power, or does not schedule any transmission of the UE; and when the priority of the D2D transmission is lower, the base station schedules, on the corresponding resources corresponding to the D2D interference sensitivity information, the transmission with higher priority of the UE at the center or the edge of the cell.

After receiving the D2D interference sensitivity information, the adjacent base station performs the corresponding interference coordination according to time information of the D2D transmission in the information. For example, within the corresponding duration time of the D2D transmission, the base station schedules, on the resources corresponding to the D2D interference sensitivity information, the cellular transmission or the D2D transmission of the UE at the center of the cell or the transmission with lower power, or does not schedule any transmission of the UE. After the corresponding time, the base station can schedule the transmission of the UE at the edge of the cell.

The interference sensitivity information providing the D2D resources can take one of a D2D transmission resource element, a D2D communication resource element, a D2D SA resource element or a D2D discovery resource element as an element, or take a PRB as an element.

In an example embodiment, it is possible to further differentiate different bit maps aiming at D2D discovery or D2D communication; the length of the bit map corresponding to D2D discovery or D2D communication is the same as a number of one of discovery resources, SA resources and data PRBs contained in the D2D resources. Moreover, the interference sensitivity information may be set on the D2D resource or the D2D resource allocated to the UE at the edge of the cell.

In an example embodiment, in some scenarios, the D2D resources of the cell can be blocked; a part is used for the D2D transmission of the UE at the center of the cell or the D2D transmission with lower power of the UE, and a part is used for the D2D transmission of the UE at the edge of the cell or the D2D transmission with higher power of the UE. Furthermore, the interference sensitivity of the D2D resource indicates the interference sensitivity information of the latter, that is, the length of the bit map is the same as the number of the D2D transmission resources of the UE at the edge of the cell or the D2D transmission resources with higher power of the UE.

Above-mentioned block information of the D2D resources can be configured through an interaction between adjacent cells, or be configured by an OAM.

The D2D interference sensitivity information and the interference sensitivity information of existing cellular resources can be indicated uniformly in an IE, or indicated separately. When they are indicated uniformly, it is also needed to indicate which information is the interference sensitivity information corresponding to the D2D resource. For example, the D2D resource (pool) information is also sent to the adjacent cell by means of interaction between the adjacent cells or being configured by the OAM. The adjacent cell can get the interference sensitivity of the corresponding D2D resource according to the information in combination with the uniform interference sensitivity information. Furthermore, when they are indicated separately, the base station should ignore the interference sensitivity information corresponding to the D2D resource in the received interference sensitivity information of the existing cellular resource.

The D2D interference sensitivity information reuses the existing IE of HII interference sensitivity information, or is indicated by using a new IE, and a D2D identifier can be added for indicating that the information is the D2D interference sensitivity information.

The D2D interference sensitivity information is carried in an X2 load information message, and the D2D interference sensitivity information is at least one of summarized and shared with the adjacent base station through the OAM or by reporting the information to at least one of the MME and the centralized information center.

The present embodiment also provides another method for D2D interference coordination, which includes that: the UE sends to the base station the D2D interference sensitivity information which is used for indicating the level of sensitivity to interference of the D2D transmission performed on radio resources or indicating the level of sensitivity to interference of the D2D transmission to be performed on radio resources, in which the D2D interference sensitivity information is used for indicating the base station to perform interference coordination.

The interference sensitivity information indicates the level of sensitivity to interference of the D2D transmission applied or the level of sensitivity to interference of the D2D transmission performed on the corresponding resource. Furthermore, the interference sensitivity information indicates whether to schedule the D2D transmission with higher level of sensitivity to interference or the D2D transmission with high priority. The different values of the level of sensitivity to interference respectively indicate the different levels of sensitivity to interference of the D2D transmission. In addition, the D2D interference sensitivity information indicates the level of sensitivity to interference, which can be high, medium and low for representing different levels of sensitivity to interference.

In an example embodiment, the high level means that the adjacent base station is required to not schedule on the resource the cellular transmission or the D2D transmission which is easy to interfere with the cell, for example, the transmission of the UE at the edge of the cell or the transmission with higher power.

The D2D interference sensitivity information includes one of the followings: time, the group identifier of the D2D transmission, the priority, the resource information corresponding to the D2D transmission, and so on. The time indicates the valid time of the D2D interference sensitivity information or the duration time of the D2D transmission.

The D2D interference sensitivity information can take one of the D2D transmission resource element, the D2D communication resource element, the D2D SA resource element and the D2D discovery resource element as an element, or take the PRB as an element. Moreover, it is possible that the D2D UE at the edge of the cell reports the interference status.

In an example embodiment, it is possible to further differentiate different bit maps aiming at the D2D discovery or the D2D communication; the length of the bit map corresponding to D2D discovery or D2D communication is the same as a number of one of discovery resources, SA resources and data PRBs contained in the D2D resources.

In an example embodiment, the D2D resources of the cell are blocked; a part is used for the D2D transmission of the UE at the center of the cell or the D2D transmission with lower power of the UE, and a part is used for the D2D transmission of the UE at the edge of the cell or the D2D transmission with higher power of the UE. Preferably, D2D interference status information indicates the D2D interference status information of the latter, that is, the length of the bit map is the same as the number of the D2D transmission resources of the UE at the edge of the cell or the D2D transmission resources with higher power of the UE.

The block information of the D2D resources can be configured through an interaction between the adjacent cells, or be configured by an OAM.

In an example embodiment, a triggering way of sending, by the UE, the D2D interference sensitivity information to the base station comprises one of the followings: event triggering, periodic reporting, and timer triggering.

The event triggering includes one of the followings:

1) the UE detects interference or resource conflict of the D2D transmission; it can be that the UE detects interference or resource conflict of the D2D transmission when monitoring or receiving the D2D transmission of other UE, or the UE detects that the D2D transmission of the UE is interfered or has resource conflict, for example, the UE learns by monitoring or receiving a feedback of the UE;

2) the UE receives a reporting request from the base station;

3) the UE has a D2D transmission resource requirement, or has a D2D signal or D2D data to be transmitted.

The periodic reporting is that the UE collects the D2D interference status corresponding to each resource granularity, and periodically reports an average value. The element of the resource can be the D2D discovery resource element, or the SA resource element, or the data resource element, or the PRB. And, the data resource can be the resource corresponding to the D2D communication that the UE is interested in.

A terminal can report the D2D interference sensitivity information through one of terminal assistance information, measurement report, RRC connection establishment and TAU request process, and a new message.

The base station performs interference processing according to the D2D interference sensitivity information reported by the UE, and the interference processing includes one of the followings.

1) The base station performs resource allocation or scheduling adjustment for the corresponding D2D transmission according to the D2D interference sensitivity information. For example, if the corresponding D2D transmission is in the cell, and the D2D interference sensitivity information shows that the D2D interference sensitivity is higher or the D2D transmission has a high priority, the base station allocates or schedules other resources or resources less prone to interference for the corresponding D2D transmission.

2) The base station reports the D2D interference sensitivity information to the adjacent base station according to the D2D interference sensitivity information reported by the UE. Furthermore, the base station obtains the possible interference source cell or base station according to at least one of the D2D interference sensitivity information reported by the UE and the D2D resource (pool) information of the adjacent base station. In addition, reporting the D2D interference sensitivity information to the adjacent base station means that the base station reports the D2D interference sensitivity information to the possible interference source cell or base station, and the D2D interference sensitivity information reported by the UE contains an identifier of the cell or base station where the UE is.

In an example embodiment, the adjacent base station performs the corresponding interference coordination according to the information after receiving the D2D interference sensitivity information. For example, when the interference status information is high, the adjacent base station tries not to schedule on the resource the cellular transmission or the D2D transmission which is easy to interfere with the cell, e.g., the transmission of the UE at the edge of the cell or the transmission with higher power.

3) The UE at least one of summarizes and shares the D2D interference sensitivity information reported by the UE through the OAM or by reporting the information to at least one of the MME and the centralized information center.

The base station acquires the D2D interference sensitivity information of the adjacent base station through at least one of the OAM, the MME and the centralized information center.

The present embodiment also provides a device for D2D interference coordination, which is applied to the base station. The device is used for implementing the above D2D interference coordination method. FIG. 4 is a structural schematic diagram of a device for D2D interference coordination according to an embodiment of the disclosure. As shown in FIG. 4, the device includes: an acquiring component 42 and a coordinating component 44; and the acquiring component 42 is arranged to acquire the D2D interference sensitivity information, in which the D2D interference sensitivity information is used for indicating the level of sensitivity to interference of the D2D transmission performed on radio resources or indicating the level of sensitivity to interference of the D2D transmission to be performed on radio resources; the coordinating component 44 is coupled with the acquiring component 42, and is arranged to perform interference coordination according to the D2D interference sensitivity information.

Note that, the components and elements involved in the embodiment of the disclosure can be realized by means of software or hardware. The components and elements described in the present embodiment can also be set in a processor; for example, it can be described as: a processor includes an acquiring component 42 and a coordinating component 44. The names of these components do not form a limit to these components themselves in some case; for example, the acquiring component 42 can also be described as “a component which is arranged to acquire the D2D interference sensitivity information”. Besides, the device for D2D interference coordination described in the embodiment of the device corresponds to the above embodiment of the method, and the specific implementation process has been elaborated in the embodiment of the method, and will not be repeated here.

FIG. 5 is a structural diagram of a device for D2D interference coordination according to a first example embodiment of the disclosure; as shown in FIG. 5, the coordinating component 44 may also include at least one of the following elements: a scheduling element 442, which is coupled with the acquiring component 42 and is arranged to perform resource allocation or scheduling adjustment for the D2D transmission according to the D2D interference sensitivity information; a first sending element 444, which is coupled with the acquiring component 42 and is arranged to send the D2D interference sensitivity information to the adjacent base station of the base station; and a second sending element 446, which is coupled with the acquiring component 42 and is arranged to send the D2D interference sensitivity information to the processing center.

FIG. 6 is a structural diagram of a device for D2D interference coordination according to a second example embodiment of the disclosure; as shown in FIG. 6, the scheduling element 442 may also include a first determining subelement 4422 and a scheduling subelement 4424; in which, the first determining subelement 4422 is arranged to determine, according to the D2D interference sensitivity information, the level of sensitivity to interference of the D2D transmission performed, by a sender of the D2D interference sensitivity information, on the radio resources; the scheduling subelement 4424 is coupled with the first determining subelement 4422 and is arranged to, when the level of sensitivity is higher than the first preset value, preferentially schedule on the radio resources the cellular transmission or the D2D transmission which is not easy to interfere with the cell, or not schedule any transmission.

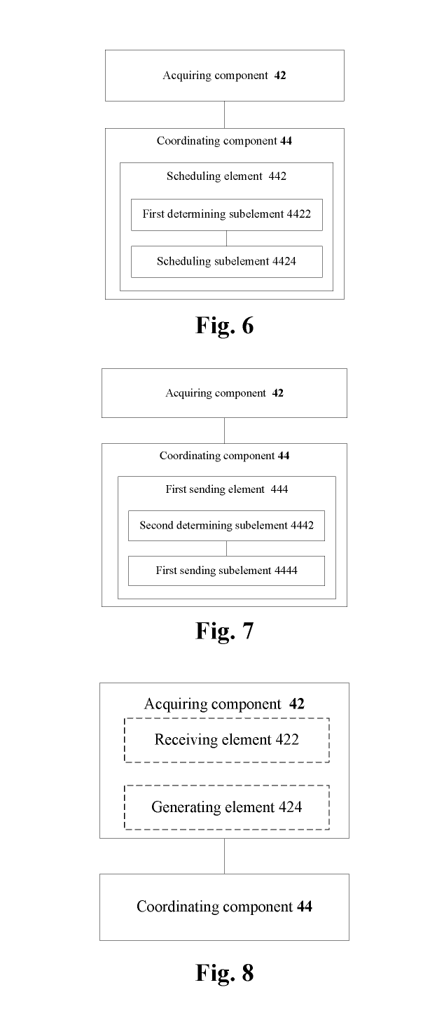

FIG. 7 is a structural diagram of a device for D2D interference coordination according to a third example embodiment of the disclosure; as shown in FIG. 7, the first sending element 444 may also include a second determining subelement 4442 or a first sending subelement 4444, in which the second determining subelement 4442 is arranged to determine the possible interference source cell or a base station according to at least one of the D2D interference sensitivity information and the D2D resource information of the adjacent base station; the first sending subelement 4444 is coupled to the second determining subelement 4442 and is arranged to send the D2D interference sensitivity information to the determined possible interference source cell or base station.

FIG. 8 is a structural diagram of a device for D2D interference coordination according to a fourth example embodiment of the disclosure; as shown in FIG. 8, the acquiring component may also include at least one of the followings: a receiving element 422 and a generating element 424; in which, the receiving element 422 is arranged to receive the D2D interference sensitivity information sent by the UE or the adjacent base station; the generating element 424 is arranged to generate the D2D interference sensitivity information according to the interference status of the radio resources.

The present embodiment also provides a base station, which includes the device for D2D interference coordination applied to the base station.

The present embodiment also provides another device for D2D interference coordination, which is applied to the UE; the device includes a sending component 52; the sending component 52 is arranged to send the D2D interference sensitivity information which is used for indicating the level of sensitivity to interference of the D2D transmission performed on radio resources or indicating the level of sensitivity to interference of the D2D transmission to be performed on radio resources, in which the D2D interference sensitivity information is used for indicating the base station to perform interference coordination.

The present embodiment also provides a UE, which includes the device for D2D interference coordination applied to the UE.

In order to make the technical solution and implementation method of the disclosure more clear, the implementation process is elaborated below in combination with the example embodiments.

### Embodiment of Method 1

The present embodiment describes a method for the base station to provide the D2D interference sensitivity information to the adjacent base station. The method includes the following steps.

At S1: the base station provides provide the D2D interference sensitivity information to the adjacent base station through an X2 load information message. The information indicates the level of sensitivity to interference of the D2D transmission performed on the corresponding radio resource or indicates the level of sensitivity to interference of the D2D transmission to be performed on radio resources, namely whether to schedule, on the corresponding resource, the D2D transmission of the UE at the edge or the D2D transmission with a higher level of sensitivity to interference or a higher priority. The different values of the level of sensitivity to interference respectively indicate the different levels of sensitivity to interference of the D2D transmission on the corresponding resource. Moreover, the D2D interference sensitivity information indicates the level of sensitivity to interference of the D2D transmission, which can be high, medium and low for representing different levels of sensitivity to interference. For example, the high level means that the adjacent base station is required to not schedule on the resource the cellular transmission or the D2D transmission which is easy to interfere with the cell, for example, the transmission of the UE at the edge of the cell or the transmission with higher power. In addition, the D2D interference sensitivity information includes one of the followings: time, the group identifier of the D2D transmission, the priority, the resource information corresponding to the D2D transmission, and so on. The time indicates the valid time of the D2D interference sensitivity information or the duration time of the D2D transmission.

At S2: after receiving the D2D interference sensitivity information, the adjacent base station performs the corresponding interference coordination according to the information. For example, when the D2D interference sensitivity information is high, the adjacent base station tries not to schedule on the resource the cellular transmission or the D2D transmission which is easy to interfere with the cell, e.g., the transmission of the UE at the edge of the cell or the transmission with higher power.

In an example embodiment, after receiving the D2D interference sensitivity information, the adjacent base station performs the corresponding interference coordination according to the group number or the priority of the D2D transmission in the information. For example, when the priority of the D2D transmission is higher, the base station schedules, on the corresponding resources corresponding to the D2D interference sensitivity information, the cellular transmission or the D2D transmission of the UE at the center of the cell or the transmission with lower power, or does not schedule any transmission of the UE. When the priority of the D2D transmission is lower, the base station schedules, on the corresponding resources corresponding to the D2D interference sensitivity information, the transmission with higher priority of the UE at the center or the edge of the cell.

In an example embodiment, after receiving the D2D interference sensitivity information, the adjacent base station performs the corresponding interference coordination according to time information of the D2D transmission in the information. For example, within the corresponding duration time of the D2D transmission, the base station schedules, on the resource corresponding to the D2D interference sensitivity information, the cellular transmission or the D2D transmission of the UE at the center of the cell or the transmission with lower power, or does not schedule any transmission of the UE. After the corresponding time, the base station can schedule the transmission of the UE at the edge of the cell.

The interference sensitivity information providing the D2D resources takes one of the D2D transmission resource element, the D2D communication resource element, the D2D SA resource element and the D2D discovery resource element as an element, or takes the PRB as an element.

The interference sensitivity information of the D2D resource is provided in form of bit map. It is possible to further differentiate different bit maps aiming at the D2D discovery or the D2D communication; the length of the bit map corresponding to D2D discovery or D2D communication is the same as a number of one of discovery resources, SA resources and data PRBs contained in the D2D resources, and the interference sensitivity information may be set on the D2D resource or the D2D resource allocated to the UE at the edge of the cell.

The D2D resources of the cell are blocked; a part is used for the D2D transmission of the UE at the center of the cell or the D2D transmission of the UE with lower power, and a part is used for the D2D transmission of the UE at the edge of the cell or the D2D transmission with higher power of the UE. Moreover, the interference sensitivity of the D2D resource indicates the interference sensitivity information of the latter, that is, the length of the bit map is the same as the number of the D2D transmission resources of the UE at the edge of the cell or the D2D transmission resources with higher power of the UE.

The block information of the D2D resources can be configured through an interaction between the adjacent cells, for example, through an eNB configuration update message or a load information message, or be configured by an OAM.

The interference sensitivity information of the D2D resource and the interference sensitivity information of existing cellular resources can be indicated uniformly in an IE, or indicated separately. When they are indicated uniformly, it is also needed to indicate which information is the interference sensitivity information corresponding to the D2D resources. For example, the D2D resource (pool) information is also sent to the adjacent cell by means of interaction between the adjacent cells or being configured by the OAM. The adjacent cell can get the interference sensitivity of the corresponding D2D resource according to the information in combination with the uniform interference sensitivity information. When the D2D interference sensitivity information and interference status information of existing cellular resources are indicated separately, the base station should ignore the interference sensitivity information corresponding to the D2D resource in the received interference sensitivity information of the existing cellular resource.

The D2D interference sensitivity information reuses the existing IE of HII interference sensitivity information, or is indicated by using a new IE. Moreover, a D2D identifier can be added for indicating that the information is the D2D interference sensitivity information.

### Embodiment of Method 2

The present embodiment describes a method for the UE to report the D2D interference sensitivity information to the base station. The method includes the following steps.

At S1: the UE reports the D2D interference sensitivity information to the base station, in which the D2D interference sensitivity information indicates the level of sensitivity to interference of the D2D transmission applied or the level of sensitivity to interference of the D2D transmission performed on the corresponding resource. Furthermore, the interference sensitivity information indicates whether to schedule the D2D transmission with higher level of sensitivity to interference or the D2D transmission with high priority. In addition, the D2D interference sensitivity information indicates the level of sensitivity to interference, which can be high, medium and low for representing different levels of sensitivity to interference.

In an example embodiment, the D2D interference sensitivity information includes one of the followings: time, the group identifier of the D2D transmission, the priority, the resource information corresponding to the D2D transmission, and so on. The time indicates the valid time of the D2D interference sensitivity information or the duration time of the D2D transmission.

At S2: the base station performs interference processing according to the D2D interference sensitivity information reported by the UE.

The interference processing includes one of the followings.

1) The base station performs resource allocation or scheduling adjustment for the corresponding D2D transmission according to the D2D interference sensitivity information. For example, if the corresponding D2D transmission is in the cell, and the D2D interference sensitivity information shows that the D2D interference sensitivity is higher or the D2D transmission has a high priority, the base station allocates or schedules other resources or resources less prone to interference for the corresponding D2D transmission.

2) The base station reports the D2D interference sensitivity information to the adjacent base station according to the D2D interference sensitivity information reported by the UE. Moreover, the base station obtains the possible interference source cell or base station according to at least one of the D2D interference sensitivity information reported by the UE and the D2D resource (pool) information of the adjacent base station. Furthermore, reporting the D2D interference sensitivity information to the adjacent base station means that the base station reports the D2D interference sensitivity information to the possible interference source cell or base station.

3) The UE at least one of summarizes and shares the D2D interference sensitivity information reported by the UE through the OAM or by reporting the information to at least one of the MME and the centralized information center.

The D2D interference sensitivity information can take one of the D2D transmission resource element, the D2D communication resource element, the D2D SA resource element and the D2D discovery resource element as an element, or take the PRB as an element. And, it is possible that the D2D UE at the edge of the cell reports the interference status.

It is possible to further differentiate different bit maps aiming at the D2D discovery or the D2D communication; the length of the bit map corresponding to D2D discovery or D2D communication is the same as a number of one of discovery resources, SA resources and data PRBs contained in the D2D resources.

The D2D resources of the cell are blocked; a part is used for the D2D transmission of the UE at the center of the cell or the D2D transmission with lower power of the UE, and a part is used for the D2D transmission of the UE at the edge of the cell or the D2D transmission with higher power of the UE. Moreover, D2D interference status information indicates the D2D interference status information of the latter, that is, the length of the bit map is the same as the number of the D2D transmission resources of the UE at the edge of the cell or the D2D transmission resources with higher power of the UE.

The block information of the D2D resources can be configured through an interaction between the adjacent cells, or be configured by an OAM.

In an example embodiment, a triggering way of sending, by the UE, the D2D interference sensitivity information to the base station comprises one of the followings: event triggering, periodic reporting, and timer triggering.

The event triggering includes one of the followings:

1) the UE detects interference or resource conflict of the D2D transmission; it can be that the UE detects interference or resource conflict of the D2D transmission when monitoring or receiving the D2D transmission of other UE, or the UE detects that the D2D transmission of the UE is interfered or has resource conflict, for example, the UE learns by monitoring or receiving a feedback of the UE;

2) the UE receives a reporting request from the base station;

3) the UE has a D2D transmission resource requirement, or has a D2D signal or D2D data to be transmitted.

The periodic reporting is that the UE collects the D2D interference status corresponding to each resource granularity, and periodically reports an average value. The element of the resource can be the D2D discovery resource element, or the SA resource element, or the data resource element, or the PRB. And, the data resource can be the resource corresponding to the D2D communication that the UE is interested in.

A terminal can report the D2D interference sensitivity information through one of terminal assistance information, measurement report, RRC connection establishment and TAU request process, and a new message.

The base station acquires the D2D interference sensitivity information of the adjacent base station through at least one of the OAM, the MME and the centralized information center.

### Embodiment of Method 3

The present embodiment describes a method that the UE reports the D2D interference sensitivity information to the base station, and after receiving the information, the base station provides the D2D interference sensitivity information to the adjacent base station to perform interference coordination. The method includes the following steps.

At S1: the UE reports the D2D interference sensitivity information to the base station, in which the D2D interference sensitivity information indicates the level of sensitivity to interference of the D2D transmission applied or the level of sensitivity to interference of the D2D transmission performed on the corresponding resource. Moreover, the interference sensitivity information indicates whether to schedule the D2D transmission with higher level of sensitivity to interference or the D2D transmission with high priority. In addition, the D2D interference sensitivity information indicates the level of sensitivity to interference, which can be high, medium and low for representing different levels of sensitivity to interference.

In an example embodiment, the D2D interference sensitivity information includes one of the followings: time, the group identifier of the D2D transmission, the priority, the resource information corresponding to the D2D transmission, and so on. The time indicates the valid time of the D2D interference sensitivity information or the duration time of the D2D transmission.

At S2: after receiving the information, the base station reports the D2D interference sensitivity information to the adjacent base station. Moreover, the base station obtains the possible interference source cell or base station according to at least one of the D2D interference sensitivity information reported by the UE and the D2D resource (pool) information of the adjacent base station. In addition, reporting the D2D interference sensitivity information to the adjacent base station means that the base station reports the D2D interference sensitivity information to the possible interference source cell or base station.

In an example embodiment, the base station can also at least one of summarize and share the D2D interference sensitivity information reported by the UE through at least one of the OAM or by reporting the information to the MME and the centralized information center.

At S3: after receiving the D2D interference sensitivity information, the adjacent base station performs the corresponding interference coordination according to the information. For example, when the D2D interference sensitivity information is high, the adjacent base station tries not to schedule on the resource the cellular transmission or the D2D transmission which is easy to interfere with the cell, e.g., the transmission of the UE at the edge of the cell or the transmission with higher power.

In an example embodiment, the D2D interference sensitivity information can take one of the D2D transmission resource element, the D2D communication resource element, the D2D SA resource element and the D2D discovery resource element as an element, or take the PRB as an element. And, it is possible that the D2D UE at the edge of the cell reports the interference status.

It is possible to further differentiate different bit maps aiming at the D2D discovery or the D2D communication; the length of the bit map corresponding to D2D discovery or D2D communication is the same as a number of one of discovery resources, SA resources and data PRBs contained in the D2D resources.

The D2D resources of the cell are blocked; a part is used for the D2D transmission of the UE at the center of the cell or the D2D transmission with lower power of the UE, and a part is used for the D2D transmission of the UE at the edge of the cell or the D2D transmission with higher power of the UE. Moreover, D2D interference status information indicates the D2D interference status information of the latter, that is, the length of the bit map is the same as the number of the D2D transmission resources of the UE at the edge of the cell or the D2D transmission resources with higher power of the UE.

The block information of the D2D resources can be configured through an interaction between the adjacent cells, or be configured by an OAM.

In an example embodiment, a triggering way of sending, by the UE, the D2D interference sensitivity information to the base station comprises one of the followings: event triggering, periodic reporting, and timer triggering.

The event triggering includes one of the followings:

1) the UE detects interference or resource conflict of the D2D transmission; preferably, it can be that the UE detects interference or resource conflict of the D2D transmission when monitoring or receiving the D2D transmission of other UE, or the UE detects that the D2D transmission of the UE is interfered or has resource conflict, for example, the UE learns by monitoring or receiving a feedback of the UE;

2) the UE receives a reporting request from the base station;

3) the UE has a D2D transmission resource requirement, or has a D2D signal or D2D data to be transmitted.

The periodic reporting is that the UE collects the D2D interference status corresponding to each resource granularity, and periodically reports an average value. The element of the resource can be the D2D discovery resource element, or the SA resource element, or the data resource element, or the PRB. And, the data resource can be the resource corresponding to the D2D communication that the UE is interested in.

A terminal can report the D2D interference sensitivity information through one of terminal assistance information, measurement report, RRC connection establishment and TAU request process, and a new message.

The base station acquires the D2D interference sensitivity information of the adjacent base station through at least one of the OAM, the MME and the centralized information center.

### Embodiment of Method 4

The present embodiment describes a method that the UE reports the D2D interference sensitivity information to the base station, and the base station performs interference coordination after receiving the information. The method includes the following steps.

At S1: the UE reports the D2D interference sensitivity information to the base station, in which the D2D interference sensitivity information indicates the level of sensitivity to interference, which can be high, medium and low for representing different levels of sensitivity to interference.

In an example embodiment, the D2D interference sensitivity information includes one of the followings: time, the group identifier of the D2D transmission, the priority, the resource information corresponding to the D2D transmission, and so on. The time indicates the valid time of the D2D interference sensitivity information or the duration time of the D2D transmission.

At S2: after receiving the information, the base station performs resource allocation or scheduling adjustment for the corresponding D2D transmission according to the D2D interference sensitivity information. For example, if the corresponding D2D transmission is in the cell, and the D2D interference sensitivity information shows that the D2D interference sensitivity is higher or the D2D transmission has a high priority, the base station allocates or schedules other resources or resources less prone to interference for the corresponding D2D transmission.

The D2D interference sensitivity information can take one of the D2D transmission resource element, the D2D communication resource element, the D2D SA resource element and the D2D discovery resource element as an element, or take the PRB as an element. And, it is possible that the D2D UE at the edge of the cell reports the interference status.

It is possible to further differentiate different bit maps aiming at the D2D discovery or the D2D communication; the length of the bit map corresponding to D2D discovery or D2D communication is the same as a number of one of discovery resources, SA resources and data PRBs contained in the D2D resources.

The D2D resources of the cell are blocked; a part is used for the D2D transmission of the UE at the center of the cell or the D2D transmission with lower power of the UE, and a part is used for the D2D transmission of the UE at the edge of the cell or the D2D transmission with higher power of the UE. Moreover, D2D interference status information indicates the D2D interference status information of the latter, that is, the length of the bit map is the same as the number of the D2D transmission resources of the UE at the edge of the cell or the D2D transmission resources with higher power of the UE.

The block information of the D2D resources can be configured through an interaction between the adjacent cells, or be configured by an OAM.

In an example embodiment, a triggering way of sending, by the UE, the D2D interference sensitivity information to the base station comprises one of the followings: event triggering, periodic reporting, and timer triggering.

The event triggering includes one of the followings:

1) the UE detects interference or resource conflict of the D2D transmission; preferably, it can be that the UE detects interference or resource conflict of the D2D transmission when monitoring or receiving the D2D transmission of other UE, or the UE detects that the D2D transmission of the UE is interfered or has resource conflict, for example, the UE learns by monitoring or receiving a feedback of the UE;

2) the UE receives a reporting request from the base station;

3) the UE has a D2D transmission resource requirement, or has a D2D signal or D2D data to be transmitted.

The periodic reporting is that the UE collects the D2D interference status corresponding to each resource granularity, and periodically reports an average value. The element of the resource can be the D2D discovery resource element, or the SA resource element, or the data resource element, or the PRB. And, the data resource can be the resource corresponding to the D2D communication that the UE is interested in.

A terminal can report the D2D interference sensitivity information through one of terminal assistance information, measurement report, RRC connection establishment and TAU request process, and a new message.

To sum up, through the above embodiments, example embodiments and implementation modes of the disclosure, aiming at the problem in the D2D discovery or the D2D communication of interference and resource conflict of the D2D transmission between the adjacent cells, and the problem of interference and resource conflict between the D2D transmission and the cellular transmission, the method avoids interference or eliminates interference based on the consideration of scheduling in advance. Compared with the related art, adopting the method and system of the embodiment of the disclosure can provide a targeted solution for interference or conflict according to the policy and priority during practical application of the D2D transmission, thereby improving the D2D service quality and user experience.

Industrial applicability: through the above embodiments, the disclosure solves the problem of poor receiving performance in D2D transmission and cellular transmission resulting from interference or resource conflict caused by inter-cell D2D transmission, and enhances the receiving performance.

Obviously, those skilled in the art should appreciate that the above components and steps of the disclosure can be implemented by a general-purpose computing device, and they can be centralized in a single computing device or distributed on a network composed of multiple computing devices; optionally, they can be implemented by a program code which is capable of being executed by the computing device, so that they can be stored in a storage device and executed by the computing device, or they are made into integrated circuit components, respectively, or multiple components and steps of them are made into a single integrated circuit component to implement. Thus, the disclosure is not limited to any particular combination of hardware and software.

The above are only the example embodiments of the disclosure and not intended to limit the disclosure; for those skilled in the art, the disclosure may have various modifications and changes. Any modifications, equivalent replacements, improvements and the like within the spirit and principle of the disclosure shall fall within the scope of the claims of the disclosure.

1. A method for Device to Device (D2D) interference coordination, comprising:
acquiring, by a base station, D2D interference sensitivity information, wherein the D2D interference sensitivity information is used for indicating a level of sensitivity to interference of a D2D transmission performed on radio resources or indicating a level of sensitivity to interference of a D2D transmission to be performed on radio resources; and performing, by the base station, interference coordination according to the D2D interference sensitivity information.

2. The method as claimed in claim 1, wherein acquiring, by the base station, the D2D interference sensitivity information comprises at least one of the followings:
receiving, by the base station, the D2D interference sensitivity information sent by a User Equipment (UE) or an adjacent base station;
generating, by the base station, the D2D interference sensitivity information according to an interference status of the radio resources.

3. The method as claimed in claim 1, wherein the D2D interference sensitivity information comprises at least one of the followings:
valid time of the D2D interference sensitivity information, duration time of the D2D transmission, a group identifier of the D2D transmission, a priority of the D2D transmission, and resource information corresponding to the D2D transmission.

4. The method as claimed in claim 1, wherein performing interference coordination according to the D2D interference sensitivity information comprises at least one of the followings:
performing, by the base station, resource allocation or scheduling adjustment for the D2D transmission according to the D2D interference sensitivity information;
sending, by the base station, the D2D interference sensitivity information to an adjacent base station of the base station; and
sending, by the base station, the D2D interference sensitivity information to a processing center.

5. The method as claimed in claim 4, wherein performing, by the base station, resource allocation or scheduling adjustment for the D2D transmission according to the D2D interference sensitivity information comprises:
etermining, by the base station, the level of sensitivity to interference of the D2D transmission performed, by a sender of the D2D interference sensitivity information, on the radio resources according to the D2D interference sensitivity information;
when the level of sensitivity is higher than a first preset value, preferentially scheduling on the radio resources a cellular transmission or a D2D transmission which is not easy to interfere with a cell, or not scheduling any transmission;
or when the D2D transmission is a transmission in a cell, performing, by the base station, resource allocation or scheduling adjustment for the D2D transmission according to the D2D interference sensitivity information comprises at least one of the followings: when the priority of the D2D transmission is higher than a second preset value, scheduling, by the base station, a transmission with lower power, or a cellular transmission or a D2D transmission of the UE at a center of the cell on the radio resources corresponding to the D2D interference sensitivity information, or not scheduling any transmission of the UE; when the priority of the D2D transmission is not higher than the second preset value, scheduling, by the base station, a transmission with higher priority of the UE at a center or an edge of the cell on the radio resource corresponding to the D2D interference sensitivity information;
or when the D2D interference sensitivity information comprises a priority of the D2D transmission, performing, by the base station, resource allocation or scheduling adjustment for the D2D transmission according to the D2D interference sensitivity information comprises at least one of the followings: when the priority of the D2D transmission is higher than the second preset value, scheduling, by the base station, a transmission with lower power, or the cellular transmission or the D2D transmission of the UE at a center of the cell on the radio resources corresponding to the D2D interference sensitivity information, or not scheduling any transmission of the UE; when the priority of the D2D transmission is not higher than the second preset value, scheduling, by the base station, a transmission with higher priority of the UE at a center or an edge of the cell on the radio resources corresponding to the D2D interference sensitivity information;
or when the D2D interference sensitivity information comprises the duration time of the D2D transmission, performing, by the base station, resource allocation or scheduling adjustment for the D2D transmission according to the D2D interference sensitivity information comprises: within the duration time of the D2D transmission, scheduling, by the base station, a transmission with lower power, or the cellular transmission or the D2D transmission of the UE at a center of the cell on the radio resources corresponding to the D2D interference sensitivity information, or not scheduling any transmission of the UE;
or sending, by the base station, the D2D interference sensitivity information to the adjacent base station of the base station comprises: determining, by the base station, a possible interference source cell or a base station according to at least one of the D2D interference sensitivity information and D2D resource information of the adjacent base station; and sending, by the base station, the D2D interference sensitivity information to the determined possible interference source cell or base station;
or the processing center comprises at least one of the followings: an Operation Administration and Maintenance (OAM) entity, a Mobile Management Entity (MME) and a centralized information center.

6.-10. (canceled)

11. The method as claimed in claim 1, wherein the radio resources corresponding to the D2D interference sensitivity information take one of a D2D transmission resource element, a D2D communication resource element, a D2D Scheduling Assignment (SA) resource element and a D2D discovery resource element as an element, or takes a Physical Resource Block (PRB) as an element.

12. The method as claimed in claim 11, wherein in a bit map carried in the D2D interference sensitivity information, a length of the bit map corresponding to D2D discovery or D2D communication is the same as a number of one of discovery resources, SA resources and data PRBs contained in the D2D resources;
or when the D2D resources of the cell of the base station are divided into a part used for the D2D transmission of the UE at the center of the cell or the D2D transmission with lower power of the UE, and a part used for the D2D transmission of the UE at the edge of the cell or the D2D transmission of with higher power the UE, the length of the bit map carried in the D2D interference sensitivity information is the same as the number of the resources used for the D2D transmission of the UE at the edge of the cell or the D2D transmission with higher power of the UE.

13. (canceled)

14. The method as claimed in claim 13, wherein block information of the D2D resources is configured through an interaction between adjacent cells, or is configured by an OAM.

15. The method as claimed in claim 1, wherein the D2D interference sensitivity information and interference status information of existing cellular resources are indicated uniformly in an Information Element (IE), or indicated separately;
or the D2D interference sensitivity information reuses overload indication information, or is indicated by using a new IE;
or the D2D interference sensitivity information is carried in an X2 load information message.

16.-17. (canceled)

18. A method for Device to Device (D2D) interference coordination, comprising:
sending to a base station, by a Equipment (UE), D2D interference sensitivity information which is used for indicating a level of sensitivity to interference of a D2D transmission performed on radio resources or indicating a level of sensitivity to interference of a D2D transmission to be performed on radio resources, wherein the D2D interference sensitivity information is used for indicating the base station to perform interference coordination.

19. The method as claimed in claim 18, wherein the D2D interference sensitivity information comprises at least one of the followings:
valid time of the D2D interference sensitivity information, duration time of the D2D transmission, a group identifier of the D2D transmission, a priority of the D2D transmission, and resource information corresponding to the D2D transmission.

20. The method as claimed in claim 18, wherein a triggering way of sending, by the UE, the D2D interference sensitivity information to the base station comprises one of the followings:
event triggering, periodic reporting, and timer triggering.

21. The method as claimed in claim 20, wherein the event triggering comprises at least one of the following ways:
he UE detects interference or resource conflict of the D2D transmission;
he UE receives a reporting request for indicating the UE to report the D2D interference sensitivity information from the base station; and
the UE has a D2D transmission resource requirement, or has a D2D signal or D2D data to be transmitted;
or the periodic reporting comprises: collecting, by the UE, a D2D interference level corresponding to each resource granularity, and periodically reporting an average value of the D2D interference level corresponding to each resource granularity, wherein a resource element of each resource granularity comprises at least one of the followings: a D2D discovery resource element, a Scheduling Assignment (SA) resource element, a data resource element, and a Physical Resource Block (PRB).

22. (canceled)

23. The method as claimed in claim 18, wherein sending, by the UE, the D2D interference sensitivity information to the base station comprises:
reporting, by the UE, the D2D interference sensitivity information through one of terminal assistance information, measurement report, Radio Resource Control (RRC) connection setup and Tracking Area Update (TAU) request process, and a new message.

24. A device for Device to Device (D2D) interference coordination, which is applied to a base station, comprising:
an acquiring component, which is arranged to acquire D2D interference sensitivity information, wherein the D2D interference sensitivity information is used for indicating a level of sensitivity to interference of a D2D transmission performed on radio resources or indicating a level of sensitivity to interference of a D2D transmission to be performed on radio resources; and
a coordinating component, which is arranged to perform interference coordination according to the D2D interference sensitivity information.

25. The device as claimed in claim 24, wherein the coordinating component comprises at least one of the followings:
scheduling element, which is arranged to perform resource allocation or scheduling adjustment for the D2D transmission according to the D2D interference sensitivity information;
first sending element, which is arranged to send the D2D interference sensitivity information to an adjacent base station of the base station; and
second sending element, which is arranged to send the D2D interference sensitivity information to a processing center;
or the acquiring component comprises at least one of the followings: a receiving element, which is arranged to receive the D2D interference sensitivity information sent by a User Equipment (UE) or a adjacent base station; and a generating element, which is arranged to generate the D2D interference sensitivity information according to an interference status of the radio resources.

26. The device as claimed in claim 25, wherein the scheduling element comprises:
a first determining subelement, which is arranged to determine the level of sensitivity to interference of the D2D transmission performed, by a sender of the D2D interference sensitivity information, on the radio resources according to the D2D interference sensitivity information;
a scheduling subelement, which is arranged to, when the level of sensitivity is higher than a first preset value, preferentially schedule on the radio resources a cellular transmission or a D2D transmission which is not easy to interfere with a cell, or not schedule any transmission;
or the first sending element comprises: a second determining subelement, which is arranged to determine a possible interference source cell or a base station according to at least one of the D2D interference sensitivity information and D2D resource information of the adjacent base station; and a first sending subelement, which is arranged to send the D2D interference sensitivity information to the determined possible interference source cell or base station.

27.-28. (canceled)

29. A device for Device to Device (D2D) interference coordination, which is applied to a User Equipment (UE), comprising:
a sending component, which is arranged to send D2D interference sensitivity information which is used for indicating a level of sensitivity to interference of a D2D transmission performed on radio resources or indicating a level of sensitivity to interference of a D2D transmission to be performed on radio resources, wherein the D2D interference sensitivity information is used for indicating the base station to perform interference coordination.

30. A base station, comprising: a device for Device to Device (D2D) interference coordination as claimed in claim 24.

31. A User Equipment (UE), comprising: a device for Device to Device (D2D) interference coordination as claimed in claim 29.
